(19) United States
(12) Patent Application Publication
(10) Pub. No.: US 2019/0129128 A1
(43) Pub. Date: May 2, 2019

(54) JOINT OF MATED COMPONENTS

(71) Applicant: COGNEX CORPORATION, Natick, MA (US)

(72) Inventors: Paul Andrew Townley-Smith, Aliso Viejo, CA (US); John McGarry, San Diego, CA (US)

(73) Assignee: COGNEX CORPORATION, Natick, MA (US)

(21) Appl. No.: 16/095,638

(22) PCT Filed: Apr. 19, 2017
(86) PCT No.: PCT/US2017/028447

§ 371 Date: Oct. 22, 2018

Related U.S. Application Data
(60) Provisional application No. 62/326,656, filed on Apr. 22, 2016.

(51) Int. Cl. G02B 7/02; G02B 27/62

(52) U.S. Cl. CPC G02B 7/025; G02B 7/008; G02B 27/62

(57) ABSTRACT

Joints are described used for mating two components of an apparatus that have been precisely aligned with respect to each other, e.g., based on a six degrees of freedom alignment procedure. For example, the precisely aligned components can be optical components that are part of an optical apparatus with highly sensitive mechanical tolerances.

### FIELD OF THE DISCLOSURE

Joints are described used for mating two components of an apparatus that have been precisely aligned with respect to each other, e.g., based on a six degrees of freedom alignment procedure. For example, the precisely aligned components can be optical components that are part of an optical apparatus with highly sensitive mechanical tolerances.

### BACKGROUND

Conventionally, joining of two components that have been aligned with high precision, often requires use of either (i) high precision parts, or (ii) complex parts with integrated alignment adjustments. The high precision parts need high precision test equipment that comes with calibration management systems that are operated by skilled operators. Because tolerances of such high precision parts are at the edge of machinability, frequent quality issues can occur. For example, the high precision parts are susceptible to handling damage that creates small burrs and other asperities that can ruin the desired quality of the part. Aside from component cost and complexity, the integrated alignment adjustments can have reduced reliability due to stresses locked into the components during fixing of the alignment.

### SUMMARY

Implementations of a joint described herein are used for mating two components of an apparatus that have been precisely aligned with respect to each other, the disclosed joint including a small number of low cost and low precision parts. Some of the parts of the disclosed joint can have high thermal conductivity and include materials with coefficients of thermal expansion (CTEs) that are well matched with the CTEs of the two components of the apparatus to be joined. In such cases, the disclosed joint, although formed from low cost, low precision parts, will be a high reliability joint.

According to an aspect of the disclosed technologies, an apparatus includes a first component of the apparatus; a second component of the apparatus; and a joint coupling the first component with the second component. Here, the second component has been precisely aligned with the first component. Additionally, the joint includes a first side defining a flat surface; a second side defining sloping faces having different orientations relative to each other; three or more rods disposed between different ones of the sloping faces and the flat surface, where each of the rods forms contact lines between the flat surface and the rod's respective sloping face; and adhesive disposed along the contact lines, the adhesive bonding together the first and second components of the apparatus.

The foregoing and other embodiments can each optionally include one or more of the following features, alone or in combination. In some implementations, the rods can include one or more rods of a first type including a first material having a coefficient of thermal expansion (CTE) that is matched with CTEs of materials of the first and second components of the apparatus; and one or more rods of a second type including a second material having a CTE that is mismatched with CTEs of the of the first and second components of the apparatus. In some cases, the first type rods and the second type rods can be disposed in an alternating manner with respect to the sloping faces. In some cases, the first material can be the same as the materials of the first and second components of the apparatus. In some cases, the first material and the materials of the first and second components of the apparatus can include thermally conductor materials; and the adhesive disposed along the contact lines formed by the first type rods can include thermal conductor adhesive. In some cases, the second material can be transparent to ultraviolet (UV) light; and the adhesive disposed along the contact lines formed by the second type rods can include UV curable adhesive. For example, the second material transparent to UV light can include one or more of fused silica or borosilicate glass.

In some implementations, the rods can include one or more rods of a cylindrical shape having a cylindrical surface, such that an associated pair of contact lines are formed by the cylindrical surface of the cylindrical shaped rod; and one or more rods of a cylindrical sector shape having a cylindrical surface and at least one flat surface, such that one of an associated pair of contact lines is formed by the cylindrical surface of the cylindrical sector shaped rod, and a second one of the associated pair of contact lines is part of a contact strip that is formed by the flat surface of the cylindrical sector shaped rod. In some cases, the flat surface can include more than one flat surface separated channels in the sector shaped rod.

In some implementations, the rods can include hollow tubes. In some implementations, the second side can include a joint base that has a base surface and the sloping faces; and an angle of the sloping faces relative to the base surface is an acute angle. In some cases, the angle of the sloping faces is between 30° and 60°.

In some implementations, the second side of the joint can define three or more sloping faces. In some cases, the three or more sloping faces can be six sloping faces.

In some implementations, the apparatus can be an optical apparatus. In some cases, the first component can include an image sensor; and the second component includes a lens arranged to image a scene on the image sensor. In some cases, the first component can include a laser arranged to illuminate a scene; and the second component includes a lens arranged to image the scene.

Particular aspects of the disclosed technologies can be implemented so as to realize one or more of the following potential advantages. For example, the disclosed joint can achieve very high precision alignment of two mated parts with small locking errors, on the order of about 1-5 microns. Locking errors are shifts from an optimized position, which was obtained by making a series of adjustments, due to stresses generated in the process of fixing the adjustments. Here, the locking errors are small because adhesive lines included in the disclosed joint can be thin, having near zero thickness at each contact line. Thin bond lines minimize locking errors caused by shrinkage of the adhesive during the cure cycle. Such thin adhesive lines render the disclosed joint very reliable, as there is little adhesive to swell due to humidity or expand/shrink over temperature due to the typically large CTE of adhesive.

As another example, the disclosed joint further can improve stability of a mount supporting an imaging sensor because the CTE is matched between the mount, joint and housing of an optical apparatus that includes the imaging sensor. In addition to the disclosed joint having components that are thermally matched and adhesive lines that are thin, symmetry of an arrangement, inside the joint, of the joint components provides additional stability.

As yet another example, the disclosed joint can have high reliability as the joint is stable over environmental changes in temperature, humidity, and mechanical vibration or shock. As yet another example, the thermal conductivity of the disclosed joint can be high, which allows for heat to be drawn away from heat generating components of an optical apparatus, e.g., an imaging sensor. In this manner, a junction temperature of the imaging sensor coupled to the apparatus' housing with the disclosed joint is reduced, which can cause improvement in the lifetime of the imaging sensor and reduction of warm-up time of the optical apparatus.

As yet another example, the disclosed joint uses a small number of components and these joint components can be low precision and low cost. This can cause cost savings in the manufacturing of the joint components as well as in the infrastructure necessary to test, qualify and validate the joint components' quality.

Details of one or more implementations of the disclosed technologies are set forth in the accompanying drawings and the description below. Other features, aspects, descriptions and potential advantages will become apparent from the description, the drawings and the claims.

### BRIEF DESCRIPTION OF THE DRAWINGS

FIG. 1 shows examples of a joint used in an optical apparatus.

FIGS. 2A-2B show aspects of one of the examples of the joint used in the optical apparatus.

FIG. 3 shows an example of a component included in the disclosed joint.

FIGS. 4A-4B show other aspects of the example of the disclosed joint.

FIGS. 5A-5B show other aspects of the example of the disclosed joint.

FIG. 6 shows aspects of another one of the examples of the joint used in the optical apparatus.

Certain illustrative aspects of the joints according to the disclosed technologies are described herein in connection with the following description and the accompanying figures. These aspects are, however, indicative of but a few of the various ways in which the principles of the disclosed technologies may be employed and the disclosed technologies are intended to include all such aspects and their equivalents. Other advantages and novel features of the disclosed technologies may become apparent from the following detailed description when considered in conjunction with the figures.

### DETAILED DESCRIPTION

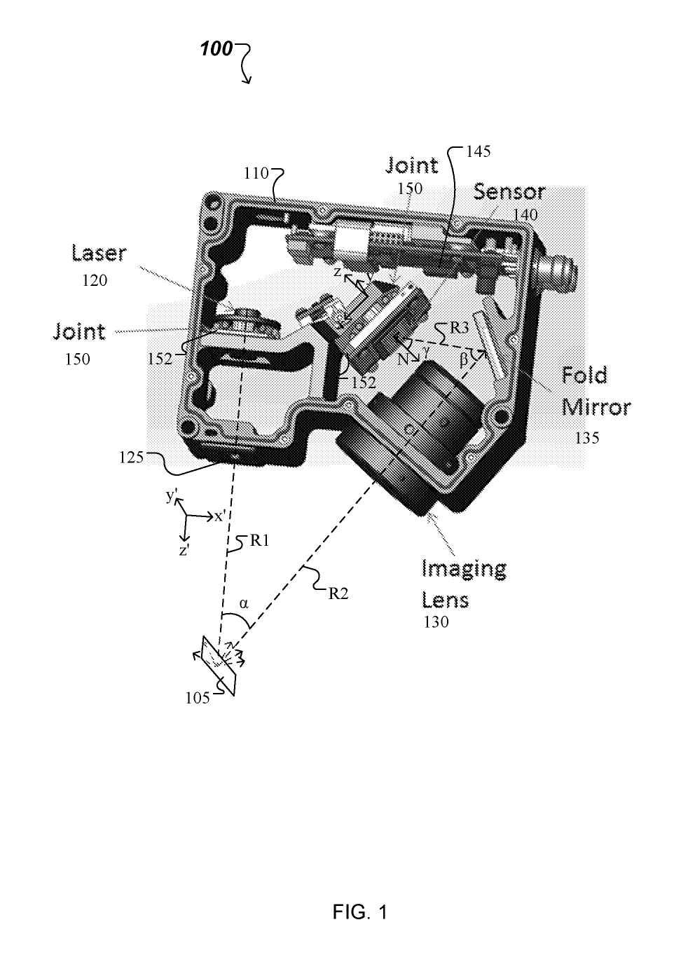

FIG. 1 is a perspective view of an optical apparatus 100 that includes multiple instances of a joint 150 between respective pairs of components of the optical apparatus. In this example, the optical apparatus 100 is a 3D laser profile sensor used to determine the profile of a scene 105, for instance. Here, the optical apparatus 100 includes a housing 110, a laser 120, an imaging lens 130, an image sensor 140, and electronics 145. The electronics 145 control operation of the laser 120 and image sensor 140 and can provide image sensor data to a remote terminal for further processing, for instance.

The housing 110 forms a stiff mounting base for supporting and arranging together all of the optical apparatus 100's components. In some implementations, the housing 110 is made, at least in part, from a material that is thermally conductive. An example of such material can be a metal, e.g., Al, or a metal alloy, e.g., brass. Such a housing 110 can dissipate heat generated by the image sensor 140 or by the laser 120. In other implementations, the housing 110 is made, at least in part, from a dielectric material, such as, e.g., plastic, glass, carbon fiber composite or ceramic.

The laser 120 is arranged to illuminate the scene 105 with a laser beam that propagates along a ray R1, in the following manner. The laser 120 incorporates a small radius cylinder lens 125 that fans the laser beam in a plane y′-z′ of a Cartesian reference system (x′, y′, z′) associated with the laser. This fanned beam forms an object plane for the imaging lens 130. The scene 105 illuminated by this object plane will be imaged by the imaging lens 130 in a plane of the image sensor 140 based only on light scattered from the surface of the scene. Since the scattered light is diffused, only a very small fraction of the laser light impinging on the surface of the scene can be collected by the imaging lens 130, especially in the case of smooth (reflective metallic surface of the) scene 105. To maximize light collection, a “fast” large aperture (low F#) imaging lens 130 is employed. This fast imaging lens 130 has a wide cone angle which creates a high sensitivity to defocus.

The above-noted object plane is tilted by an angle α relative to the optical axis of the imaging lens 130, and thus some of the scattered light that propagates along the optical axis of the imaging lens (e.g., along ray R2) creates an image tilted by angle γ relative to the optical axis, in accordance with the Scheimpflug principle. In the example shown in FIG. 1, there is a fold mirror 135 between the imaging lens 130 and the image sensor 140. The purpose of the fold mirror 135 is to deviate the light propagating along ray R2 by an angle β to make the housing 110 more compact. Moreover, the image sensor 140 is further tilted by the angle γ and translated relative to the imaging lens 130's axis so that the image sensor is conjugate with the laser plane. Thus, light impinging on the image sensor 140 along ray R3 forms the angle γ relative to a normal N to the image sensor, where the normal N is parallel to the z-axis of a Cartesian coordinate system (x, y, z) associated with the image sensor.

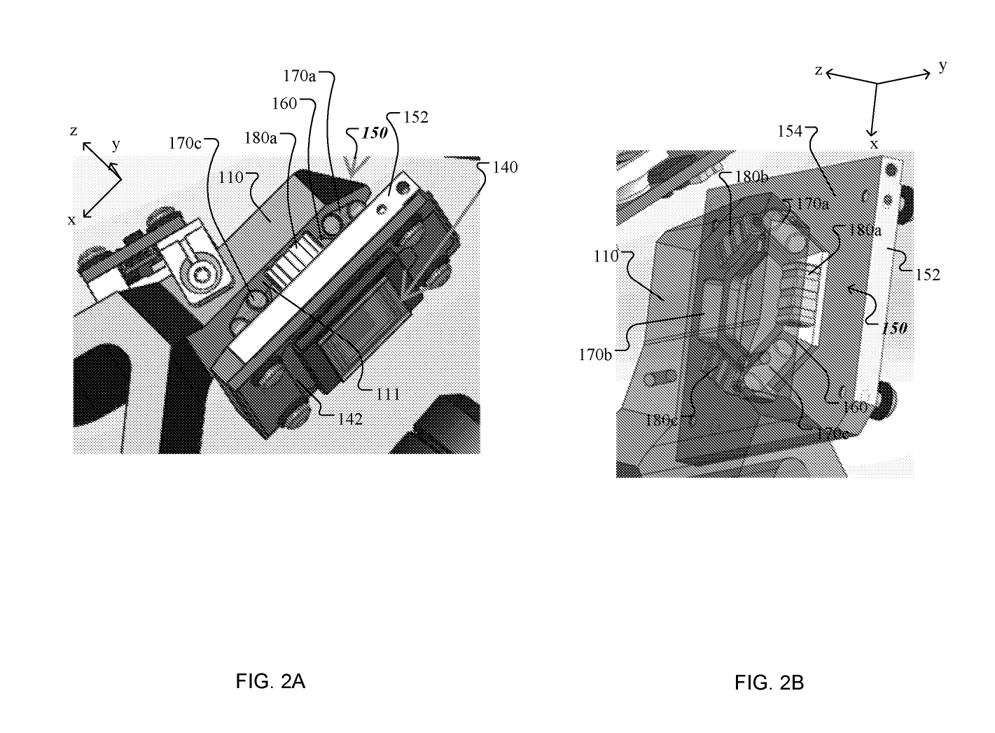

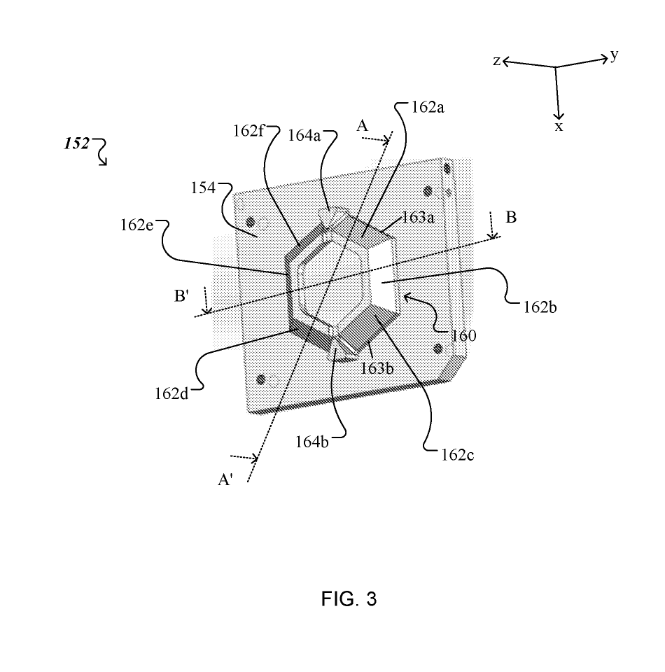

In this example, the image sensor 140 and the laser 120 each requires very high precision adjustment relative to the imaging lens 130 when mounted in the housing 110, e.g., of order 1 to 10 μm, while the other components can be mounted to the housing based only on their mechanical tolerances, without need for alignment relative to the imaging lens. For instance, the imaging lens 130 can be secured directly to the housing 110. In the case of coupling the image sensor 140 with the imaging lens 130 (via the housing 110), the image sensor is first coupled with a joint base 152 that is part of the joint 150, and then the image sensor is aligned with high precision relative to the imaging lens 130. Once the alignment error between the image sensor 140 and the imaging lens 130 has been sufficiently minimized, the joint base 152 is joined to a flat face of the housing 110 using other components of the joint 150. The joint 150 used to couple the image sensor 140 with the imaging lens 130 is described in detail below in connection with FIGS. 2A-2B, 3, 4A-4B and 5A-5B. Moreover, in the case of coupling the laser 120 with the imaging lens 130 (via the housing 110), a joint base 152 is first secured directly to the housing 110, and then the laser 120 is aligned with high precision relative to the imaging lens 130. Once the alignment error between the laser 120 and the imaging lens 130 has been sufficiently minimized, a flat face of the laser is joined to the joint base 152 using other components of the joint 150. The joint 150 used to couple the laser 120 with the imaging lens 130 is described in detail below in connection with FIG. 3, 4A-4B, 5A-5B and 6.

FIG. 2A is a close-up of the perspective view from FIG. 1 showing a joint 150 that includes a joint base 152 joined to a flat surface 111 of the housing 110. FIG. 2B is another perspective view of the joint 150 from FIG. 2A. Note that in FIG. 2B, the housing 110 is represented in a transparent manner. Here, the image sensor 140 is supported on a board 142 which in turn is secured to the back of the joint base 152 with attachment elements, e.g., set screws.

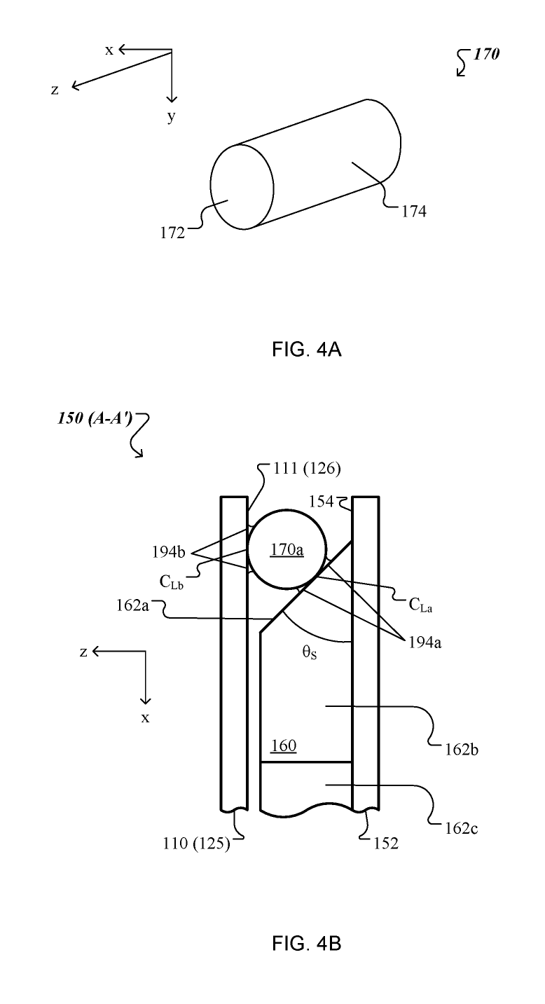

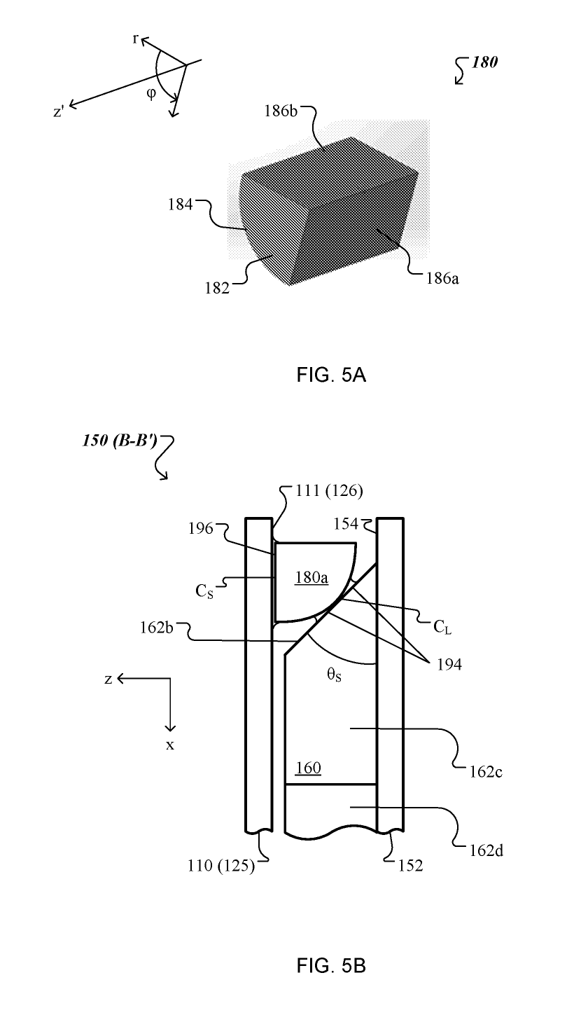

The joint base 152 includes a structure 160, also referred to as a pedestal, having faces with different orientations relative to each other. In some implementations, the joint base 152 also has a back surface 154 that is flat. Here, the faces of the structure 160 are sloping relative to the flat surface 154. Further, the joint 150 includes three or more rods that are either of a first type, e.g., rods 170a, 170b, 170c, or of a second type, e.g., rods 180a, 180b, 180c, or a mix of rods of both types. The rods are disposed between respective sloping faces of the pedestal 160 and the flat surface 111 of the housing 110 as described below in connection with FIGS. 4B and 5B. In this manner, each rod forms a pair of contact lines, one between the rod and its associated sloping face and a second one between the rod and the flat surface 111 of the housing 110. Furthermore, the joint includes adhesive disposed along the contact lines. In this manner, the adhesive bonds together the pedestal 160 of the joint base 152 and the flat surface 111 of the housing 110.

FIG. 3 shows a perspective view of a joint base 152 like the one included in the joint 150 described above in connection with FIGS. 1, 2A-2B. In some implementations, the joint base 152 can be made from a thermally conductor material, e.g., a metal. The metal from which the joint base 152 is made can be Al or Ti, for instance. In some cases, the pedestal 160 can be stamped out of the flat surface 154 of the joint base 152. In other cases, the joint base 152, including the pedestal 160, can be cast. In other implementations, the joint base 152 can be cast out of a dielectric material, e.g., plastic, glass, or ceramic.

The pedestal 160 of the joint base 152 can have three or more sloping faces 162a, 162b, 162c, etc., that are arranged to form a pedestal shaped like a truncated polygonal pyramid. Accordingly, each sloping face of the truncated polygonal pyramid-shaped pedestal 160 is shaped like a trapezoid. The shorter base of each trapezoidal sloping face 162 is equal to or longer than a length of the rods 170, 180, hence it can have a value of about 5, 10, 15 or 20 mm, for instance. In general, the length of the sloping faces 162 is dependent upon a range of the desired adjustability and basic geometry of the joint 150. For example, if the adjustability range is small, the sloping faces 162 could be very short. The height of each trapezoidal sloping face 162 is larger than a diameter (or width) of the rods 170, 180, hence it can have a value of about 2, 5 or 10 mm, or other height values. Further, each face of the truncated polygonal pyramid-shaped pedestal 160 is sloped relative to the back surface 154 by an acute sloping angle θs (as shown in FIGS. 4B and 5B). For example, the sloping angle θs can be in the range of 30-60°. Moreover, in the example shown in FIG. 3, the pedestal 160 is shaped as a truncated hexagonal pyramid with six sloping faces. In other examples, the pedestal 160 can be shaped as a truncated triangular pyramid with three sloping faces. Pedestals shaped as a truncated polygonal pyramid with four, eight, twelve or other number of sloping faces also are possible.

In some implementations, the pedestal 160 of the joint base 152 can include two or more support elements, e.g., in the form of fences 164a, 164b illustrated in FIG. 3. For example, referring to FIGS. 2A-2B and 3, the fence 164a prevents a rod from sliding, before the adhesive is fully cured, along an edge 163a of the sloping face 162a onto which the rod is disposed. As another example, the fence 164b prevents a rod from sliding, before the adhesive is fully cured, along an edge 163b of the sloping face 162c onto which the rod is disposed.

FIG. 4A is a perspective view of a first type of rod 170 like the rods 170a, 170b and 170c shown above in connection with FIGS. 2A-2B. The first type of rod 170 has bases 172 and a cylindrical surface 174. FIG. 5A is a perspective view of a second type of rod 180 like the rods 180a, 180b and 180c shown above in connection with FIGS. 2A-2B. The second type of rod 180 includes bases 182 and a cylindrical surface 184. Additionally, the second type of rod 180 further includes one or more flat surfaces 186. In the example shown in FIG. 5A (and in FIGS. 2A-2B), the second type of rod 180 is shaped as a sector of a cylinder and has two flat surfaces 186a, 186b. Moreover, an angle formed by the two flat surfaces 186a, 186b is larger than 0° and can be up to 180°. In other implementations, the second type of rod 180 can be shaped as a segment of cylinder that has a single flat surface 186.

A length of the rods 170, 180 along the z-axis can have a value of about 5, 20, 15 or 20 mm, or other length values. A radius of curvature of the cylindrical surface 174, 184 of the rods can have a value of about 1, 2.5 or 5 mm, or other radius values. In some implementations, either of the first or second type of rods 170, 180 can be solid material, i.e., can have a solid profile. In other implementations, either of the first or second type of rods 170, 180 can be hollow material, i.e., can have a hollow, tubular profile.

FIG. 4B is a side view of the joint 150, along the cross-section A-A′ of the joint base 152 shown in FIG. 3. Here, the first type of rod 170a is seated between sloping face 162a of the pedestal 160 of the joint base 152 and the flat surface 111 of the housing 110. In this case, the cylindrical surface 174 of the first type of rod 170a forms a first contact line C_{La} (e.g., oriented substantially along the y-axis) with the sloping face 162a of the pedestal 160, and a second contact line C_{Lb} (here, also oriented substantially along the y-axis) with the flat surface 111 of the housing 110. A first adhesive line 194a disposed along the first contact line C_{La} is shaped by the cylindrical surface 174 of the first type of rod 170a and of the sloping face 162a in the vicinity of the first contact line C_{La.} Similarly, a second adhesive line 194b disposed along the second contact line C_{Lb} is shaped by the cylindrical surface 174 of the first type of rod 170a and of the flat surface 111 in the vicinity of the second contact line C_{La}.

FIG. 5B is another side view of the joint 150, along the cross-section B-B′ of the joint base 152 shown in FIG. 3. Here, the second type of rod 180a is seated between sloping face 162b of the pedestal 160 of the joint base 152 and the flat surface 111 of the housing 110. In this case, the cylindrical surface 184 of the second type of rod 180a forms a contact line C_{L} (e.g., oriented substantially along the y-axis) with the sloping face 162b of the pedestal 160, and the flat surface 186a of the second type of rod forms a contact strip (or band) C_{S} (here, also oriented substantially along the y-axis) with the flat surface 111 of the housing 110. As noted above in connection with FIG. 4B, a first adhesive line 194 disposed along the contact line C_{L} is shaped by the cylindrical surface 174 of the second type of rod 180a and of the sloping face 162b in the vicinity of the contact line C_{L}. Similarly, a second adhesive line 196 disposed along the contact strip C_{S} is shaped by the flat surface 186a of the second type of rod 180a and of the flat surface 111 in the vicinity of the contact strip C_{S}. Note that optional ridge and channel structures of the flat surfaces 186a and 186b of the second type of rod 180a (as the ones illustrated in FIGS. 2A-2B) help for rod handling and for spreading of the second adhesive line 196 during the forming of the joint 150. Alternatively, the cylindrical surface 174 of the second type of rod 180a can touch the flat surface 111 of the housing 110 instead.

In some implementations, the rods 170, 180 can be made from the same material as the material of the pedestal 160 of the joint base 152 and as the material of the flat surface 111 of the housing 110. In some implementations, the rods 170, 180 can be made from a different material than, but having matching CTE with, a CTE of the material of the pedestal 160 of the joint base 152 and a CTE of the material of the flat surface 111 of the housing 110. In either of these cases, the joint 150 described above in connection with FIGS. 2A-2B, 4B and 5B will be insensitive to thermal compressions or dilations of the joint. For example, the joint 150 will be incompressible because it has rigid material contacting—along contact lines C_{L} and contact strips C_{S}—respective opposing sides of the joint. As another example, the joint 150 will not expand because the adhesive lines 194, 196 are thin.

In some implementations, when materials (e.g., Al) of the pedestal 160 of the joint base 152 and of the material (e.g., Al) of the flat surface 111 of the housing 110 have good thermal conducting properties, good thermal conducting properties also are used at least for material in the adhesive lines 194, 196 (e.g., thermal epoxies). In some cases, the rods 170, 180 also are made from materials (e.g., Al) that have good thermal conducting properties. In either of these cases, the joint 150 described above in connection with FIGS. 2A-2B, 4B and 5B creates a heat conducting path from a heat generating source (e.g., the image sensor 140 or the laser 120) and the bulk of the housing 110.

In some implementations, the first type of rods 170 can be made from a material that is transparent to light used for curing the adhesive lines 194a, 194b. For instance, if material included in the adhesive lines 194a, 194b is ultraviolet (UV) curable epoxy, then the first type of rods 170 can be made from one or more of fused silica or borosilicate glass. In this case, the UV curable epoxy lines 194a, 194b can be exposed to UV light delivered from a UV source through the glass rod 170a. In this manner, a mix of first type of rods 170 and second type of rods 170 can be used to form the joint 150, as shown in the example illustrated in FIGS. 2A-2B. Here, the glass rods 170a, 170b, 170c and the aluminum quarter round rods 180a, 180b, 180c are distributed in an alternate manner: the combination of glass rods 170a, 170b, 170c and UV curable epoxy lines is used for simplifying the fabrication process of the joint 150; and the combination of aluminum quarter round rods 180a, 180b, 180c and thermal epoxy is used to thermally match the aluminum joint base 152 of the joint 150 with the aluminum housing 110.

The joint 150 that includes (i) the aluminum joint base 152, (ii) the combination of glass rods 170a, 170b, 170c and UV curable epoxy lines, and (iii) the combination of aluminum quarter round rods 180a, 180b, 180c and thermal epoxy can be fabricated in the following manner. Once the alignment error has been sufficiently minimized, and thus the alignment of the imaging sensor 140 to the image formed by imaging lens 130 is completed, the aluminum joint base 152—that supports the aligned image sensor 140 and that itself is held by an alignment apparatus used to perform the alignment—is ready to be joined to the housing 110. A glass rod, e.g., 170a, is placed between one sloping face, e.g., 162a, of the pedestal 160 and the flat surface 111 of the housing 110—as shown in FIG. 4B. The fence 164a of the pedestal 160 is used to prevent the glass rod 170a from falling out of the joint 150 at this fabrication stage. As shown in FIGS. 2B and 4B, the geometry of joint 150 will always create a pair of contact lines C_{La}, C_{Lb} between the glass rod 170a and each of the two halves of the joint. Low viscosity UV curing epoxy is wicked into each side of each of the contact lines C_{La}, C_{Lb} and then UV light is applied through the glass rod 170a to cure the epoxy. Because of the rigid interface formed by the glass rod 170a and thin UV curing epoxy lines 194a, 194b, very little stress and displacement (which would create locking error) occurs due to UV curing epoxy shrinkage. This would not be the case if thick adhesive joints were employed, in a conventional manner, to fill up the gap between the board 142 and the flat surface 111 of the housing 110.

Note that the foregoing steps of the process can be completed in 1-2 minutes. Then, a second glass rod 170b is (i) placed between a non-adjacent sloping face, e.g., 162c, of the pedestal 160 and the flat surface 111 of the housing 110, and (ii) bonded in place in the same manner described above in connection with the bonding of the first glass rod 170a. Once the second glass rod is in place, the joint 150 is sufficiently stable to allow the joint base 152 to be released from the aligner apparatus. At this point, the optical apparatus 100, including the partially assembled joint 150, can be turned over. Then, a third and final glass rod 170c is (i) placed between the remaining non-adjacent sloping face, e.g., 162e, of the pedestal 160 and the flat surface 111 of the housing 110, and (ii) bonded in place in the same manner described above in connection with the bonding of the first and second glass rods 170a, 170b.

To finish the joint 150, three aluminum quarter round rods 180a, 180b, 180c are respectively bonded between the remaining unused sloping faces 162b, 162d, 162f of the pedestal 160 and the flat surface 111 of the housing 110. In this example, the aluminum quarter round rods 180a, 180b, 180c are bonded with thermally conducting epoxy. As shown in FIGS. 2B and 5B, for each of the aluminum quarter round rods 180a, 180b, 180c, the geometry of joint 150 will always create a contact line C_{L} and a contact strip C_{S} between the aluminum quarter round rod and respective components mated by the joint. In this manner, for each of the aluminum quarter round rods 180a, 180b, 180c, a narrow thin bond 194 and a large thin bond 196 are created, at least the latter of which having excellent thermal conductivity as well as exceptional reliability properties. In addition, by balancing the CTE of the glass rods with the CTE of the aluminum quarter round rods, a value of an “effective CTE of the joint 150” is closer to values of the CTEs of the components mated by the joint.

In some implementations, the joint 150 is further modified by removing the glass rods 170a, 170b, 170c from the joint after bonding the aluminum quarter round rods 180a, 180b, 180c inside the joint. One reason to remove glass rods 170a, 170b, 170c from the joint 150 would be to potentially reduce the thermal stress induced by leaving them in, as the glass rods have a relatively CTE compared to the aluminum components mated by the joint. These empty locations between respective sloping faces 162a, 162c, 162e and the flat surface 111 of the housing 110 could be either left blank or filed with additional aluminum quarter round rods bonded with thermal epoxy.

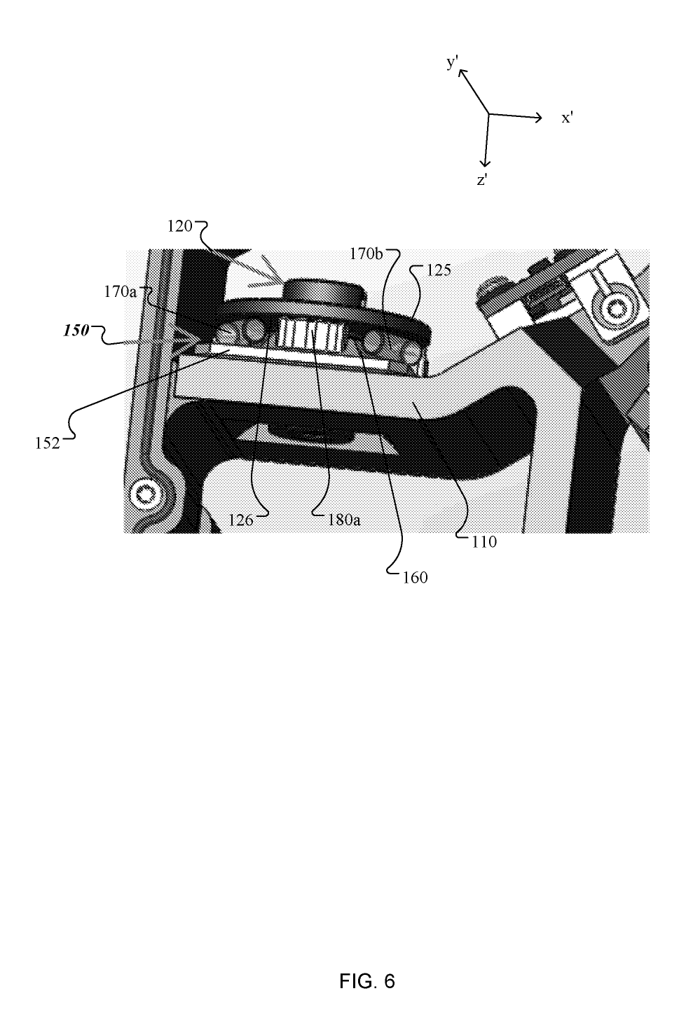

FIG. 6 is a close-up of the perspective view from FIG. 1 showing a joint 150 that joins the laser 120 to the housing 110. Here, the laser 120 is supported by a laser support 125 and the joint 150 includes a joint base 152 secured to the housing 110. A back surface of the joint base 152 faces a flat surface 126 of the laser support 125 of the laser 120.

As described above in connection with FIG. 3, the joint base 152 includes a pedestal 160 having faces that are sloping relative to the back surface of the joint base. Similarly, the joint 150 includes three or more rods that are either of the first type, e.g., rods 170a, 170b, etc., or of the second type, e.g., rods 180a, etc., or a mix of rods of both types. The rods are disposed between respective sloping faces of the pedestal 160 and the flat surface 126 of the laser support 125 as described above in connection with FIGS. 4B and 5B. In this manner, each rod forms a pair of contact lines, one between the rod and its associated sloping surface and a second one between the rod and the flat surface 126 of laser support 125. Furthermore, the joint includes adhesive disposed along the contact lines. In this manner, the adhesive bonds together the sloping surface of the joint base 152 and the flat surface 126 of laser support 125.

In the above description, numerous specific details have been set forth in order to provide a thorough understanding of the disclosed technologies. In other instances, well known structures, and processes have not been shown in detail in order to avoid unnecessarily obscuring the disclosed technologies. However, it will be apparent to one of ordinary skill in the art that those specific details disclosed herein need not be used to practice the disclosed technologies and do not represent a limitation on the scope of the disclosed technologies, except as recited in the claims. It is intended that no part of this specification be construed to effect a disavowal of any part of the full scope of the disclosed technologies. Although certain embodiments of the present disclosure have been described, these embodiments likewise are not intended to limit the full scope of the disclosed technologies.

The preceding figures and accompanying description illustrate examples of systems and devices for mating two components of an apparatus to each other securely with alignment accuracy maintained. It will be understood that these methods, systems, and devices are for illustration purposes only. Moreover, the described systems/devices may use additional parts, fewer parts, and/or different parts, as long as the systems/devices remain appropriate. In other words, although this disclosure has been described in terms of certain aspects or implementations and generally associated methods, alterations and permutations of these aspects or implementations will be apparent to those skilled in the art. Accordingly, the above description of examples of implementations does not define or constrain this disclosure. Further implementations are described in the following claims.

What is claimed is:

1. An apparatus comprising:
a first component of the apparatus;
a second component of the apparatus; and
a joint coupling the first component with the second component;
wherein the second component has been precisely aligned with the first component; and
wherein the joint comprises
a first side defining a flat surface,
a second side defining sloping faces having different orientations relative to each other,
three or more rods disposed between different ones of the sloping faces and the flat surface, wherein each of the rods forms contact lines between the flat surface and the rod's respective sloping face, and
adhesive disposed along the contact lines, the adhesive bonding together the first and second components of the apparatus.

2. The apparatus of claim 1, wherein the rods include
one or more rods of a first type comprising a first material having a coefficient of thermal expansion (CTE) that is matched with CTEs of materials of the first and second components of the apparatus, and
one or more rods of a second type comprising a second material having a CTE that is mismatched with CTEs of the first and second components of the apparatus.

3. The apparatus of claim 2, wherein the first type rods and the second type rods are disposed in an alternating manner with respect to the sloping faces.

4. The apparatus of claim 2, wherein the first material is the same as the materials of the first and second components of the apparatus.

5. The apparatus of claim 2, wherein
the first material and the materials of the first and second components of the apparatus comprise thermally conductor materials, and
the adhesive disposed along the contact lines formed by the first type rods comprises thermal conductor adhesive.

6. The apparatus of claim 2, wherein
the second material is transparent to ultraviolet (UV) light, and
the adhesive disposed along the contact lines formed by the second type rods comprises UV curable adhesive.

7. The apparatus of claim 6, wherein the second material transparent to UV light comprises one or more of fused silica or borosilicate glass.

8. The apparatus of claim 1, wherein the rods include
one or more rods of a cylindrical shape having a cylindrical surface, such that an associated pair of contact lines are formed by the cylindrical surface of the cylindrical shaped rod, and
one or more rods of a cylindrical sector shape having a cylindrical surface and at least one flat surface, such that one of an associated pair of contact lines is formed by the cylindrical surface of the cylindrical sector shaped rod, and a second one of the associated pair of contact lines is part of a contact strip that is formed by the flat surface of the cylindrical sector shaped rod.

9. The apparatus of claim 8, wherein the flat surface comprises more than one flat surface separated channels in the sector shaped rod.

10. The apparatus of claim 1, wherein the rods comprise hollow tubes.

11. The apparatus of claim 1, wherein
the second side comprises a joint base that includes a base surface and the sloping faces, and
an angle of the sloping faces relative to the base surface is an acute angle.

12. The apparatus of claim 11, wherein the angle of the sloping faces is between 30° and 60°.

13. The apparatus of claim 1, wherein the second side of the joint defines three or more sloping faces.

14. The apparatus of claim 13, wherein the three or more sloping faces are six sloping faces.

15. The apparatus of claim 1, wherein the apparatus is an optical apparatus.

16. The apparatus of claim 15, wherein
the first component comprises an image sensor, and
the second component comprises a lens arranged to image a scene on the image sensor.

17. The apparatus of claim 15, wherein
the first component comprises a laser arranged to illuminate a scene, and
the second component comprises a lens arranged to image the scene.
